(19) United States
(12) Patent Application Publication
(10) Pub. No.: US 2009/0229545 A1
(43) Pub. Date: Sep. 17, 2009

(54) Crankshaft for integral gas compressor and internal combustion engine

(75) Inventors: Michael Kenneth Atkinson, Midwest City, OK (US); George E. Folks, Norman, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(73) Assignee: Compressco, Inc., Oklahoma City, OK (US)

(21) Appl. No.: 12/075,656

(22) Filed: Mar. 13, 2008

(51) Int. Cl. F02B 75/22

(52) U.S. Cl. 123/54.4; 123/197.4; 123/192.2

(57) ABSTRACT

A crankshaft for an integral gas compressor and internal combustion engine. The cylinder block of the integral gas compressor and internal combustion engine has a bank of compressor cylinders and a bank of engine cylinders, such as in a V-shaped configuration. The crankshaft has four journals, each adapted to carry two connecting rods. The journals include two coaxial end journals and two coaxial intermediate journals.

### BACKGROUND

Reciprocating gas compressors are well known in the art, and some are suitable for use in handling flammable gases such as natural gas. One type of gas compressor used in these applications is integral with an internal combustion engine.

Previously, the construction of an integral gas compressor and internal combustion engine included removing some of the engine components and replacing them with compressor components. For example, U.S. Pat. No. 2,133,769 to Jones discloses an engine-compressor unit with one side of a V-shaped engine, in this case a Ford V-8, being converted to an air compressor. In this apparatus, the engine head on one bank of cylinders is removed, along with the pistons and engine intake and exhaust valves, valve push rods and valve springs. A compressor head is installed on that bank of cylinders of the engine in place of the engine head, and compressor intake and exhaust valves are installed in the compressor head. The Jones apparatus is made from a flathead engine in which the valves are mounted in the engine block below the engine head, and the compressor head covers the existing openings through which the engine valve originally extended. In Jones, apparatus is designed for use with atmospheric air only, and does not address the problems involved with handling gases with inlet pressures above atmospheric pressure or gases which are flammable, such as natural gas.

An integral gas compressor and internal combustion engine designed for flammable gases and above atmospheric inlet pressures is disclosed in U.S. Pat. Nos. 4,961,891; 5,189,905; 5,203,680; and 5,267,843 to Waldrop, assigned to the assignee of the present invention. This compressor is shown constructed using a converted V-8 engine. The compressor head on this apparatus manifolds a plurality of inlet valves together. The engine for this compressor is a V-8 engine of a more modern overhead-valve type than the flathead of Jones. In this overhead-valve engine, the cylinder block, also sometimes referred to as the engine block, has a longitudinally extending port therethrough with a plurality of openings intersecting the port substantially perpendicular thereto. Engine valves are mounted on the engine head under a valve cover, and valve push rods are disposed in the openings in the cylinder block to engage valve rocker arms which in turn actuate the valves. The longitudinal port, also referred to as an oil gallery, provides a lubrication path from the engine oil pump to the valve push rods. When converting one side of an existing engine to a compressor, opposite ends of the longitudinal port and all of the intersecting openings have to be plugged. This not only adds to the cost of building the compressor but can also be a source of oil leaks if any of the plugs do not seal properly. Therefore, there is a need for a cylinder block where it is not necessary to plug ports or openings. U.S. patent application Ser. No. 11/247,108 published as US 2007-0079778A1 addresses such concerns.

An additional concern with the integral gas compressor and internal combustion engine is that it may run roughly, or unevenly, due to the configuration of the typical V-8 crankshaft normally used with such apparatus. This disclosure describes a crankshaft that creates a firing order that allows the apparatus to run smoothly.

### SUMMARY

A cylinder block designed for use in an integral gas compressor and internal combustion engine uses a crankshaft that changes the normal firing order that would occur with a prior art crankshaft. The block comprises an engine portion defining an engine cylinder therein with a valve train opening defined adjacent to the engine cylinder and also comprises a compressor portion defining a compressor cylinder therein wherein the compressor portion may have no valve train opening. The valve train opening in the engine portion is adapted for receiving an engine valve train component therein.

The compressor cylinder and engine cylinder preferably form a V-shaped configuration. In one embodiment, the cylinder block has a V-8 configuration wherein the engine cylinder is one of four engine cylinders, the compressor cylinder is one of four compressor cylinders and the valve train opening is one of a plurality of valve train openings adjacent to the engine cylinders.

Stated in another way, the cylinder block comprises a first section with a plurality of cylinders defined therein and having a plurality of bosses integrally formed thereon and a second section with a plurality of cylinders defined therein and having a plurality of bosses integrally formed thereon. The bosses on one of the first and second sections are solid, and the bosses on the other of the first and second sections define valve train openings therein for receiving a portion of an engine valve train therein. Each of the cylinders on the one section are adapted for receiving a compressor piston therein, and each of the cylinders on the other section are adapted for receiving an engine piston therein. Preferably, the first and second sections form a V-shaped configuration, such as a V-8 configuration with four cylinders each.

The integral gas compressor and internal combustion engine apparatus comprises a cylinder block defining a set of compressor cylinders and a set of engine cylinders therein and further defining valve train openings adjacent to the set of engine cylinders only, a crankshaft rotatably disposed in the cylinder block, a compressor piston disposed in each of the compressor cylinders, an engine piston disposed in each of the engine cylinders, a connecting rod connecting each of the compressor and engine pistons to the crankshaft, a compressor head with compressor valves therein adjacent to the compressor cylinders, an engine head adapted for receiving engine valves therein adjacent to the engine cylinders, a cam rotatably disposed in the cylinder block, and an engine valve train including engine valves and engaging the cam, a portion of the engine valve train extending through the valve train openings.

Preferably, the portion of the valve train extending though the valve train openings comprises a plurality of valve push rods.

The cylinder block in the compressor further defines an oil gallery connectable to an engine oil pump and in communication with the valve train openings. The cylinder block may have a V-shaped configuration having a pair of banks, wherein the compressor cylinders are defined in one bank and the engine cylinders are defined in the other bank, and may be a V-8 configuration with four compressor cylinders and four engine cylinders. The valve train openings may be completely defined in the bank defining the engine cylinders.

The crankshaft used in the apparatus has four journals, two end journals and two intermediate journals. The two end journals are coaxial, and the two intermediate journals are coaxial. The crankshaft changes the firing order from that which would occur with a typical prior art V-8 crankshaft and causes the apparatus to run more evenly.

Numerous objects and advantages of the invention will become apparent as the following detailed description of the preferred embodiment is read in conjunction with the drawings illustrating such embodiment.

### BRIEF DESCRIPTION OF THE DRAWINGS

FIG. 1 generally shows a compressor package of the type which utilizes the cylinder block for an integral gas compressor and internal combustion engine of the present invention.

FIG. 2 is a plan view of the compressor package of FIG. 1.

FIG. 3 is an end view of an integral gas compressor and internal combustion engine showing the cylinder block of the present invention.

FIG. 4 is a perspective view of the cylinder block.

FIG. 5 is a vertical cross section taken along lines 5-5 in FIG. 4.

FIG. 6 is a horizontal cross section taken along lines 6-6 in FIG. 5.

FIG. 7 is a prior V-8 crankshaft.

FIG. 8 is a prior art V-8 crankshaft with connecting rods mounted thereto.

FIG. 9 is a view of the crankshaft of the current invention.

FIG. 10 is a crankshaft of the current invention with connecting rods mounted thereto.

FIG. 11 is a representative view looking down at the engine and compressor cylinders.

### DETAILED DESCRIPTION OF THE PREFERRED EMBODIMENT

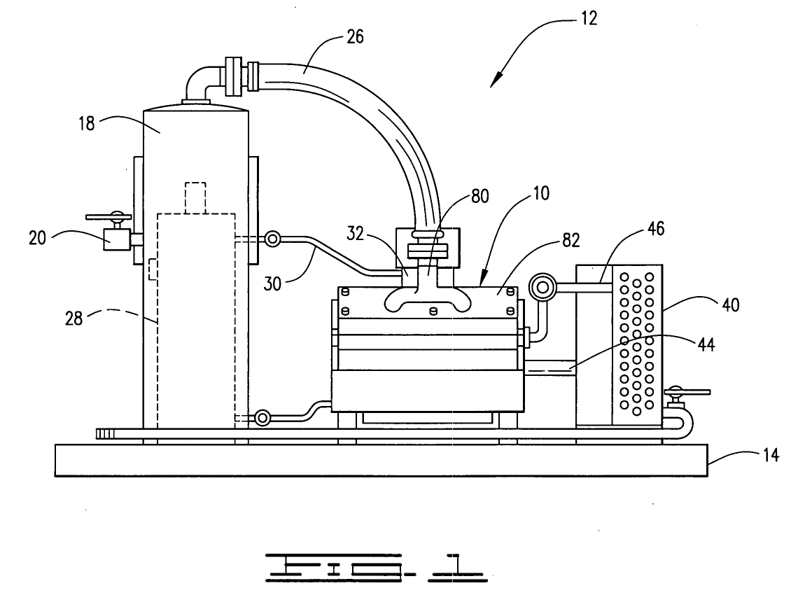

Referring now to the drawings, and more particularly to FIG. 1, an integral gas compressor and internal combustion engine apparatus which incorporates the crankshaft of the present invention is shown and generally designated by the numeral 10. Compressor 10 is shown as a portion of a compressor package 12. Integral gas compressor and internal combustion engine 10 will also be referred to herein as simply compressor apparatus 10.

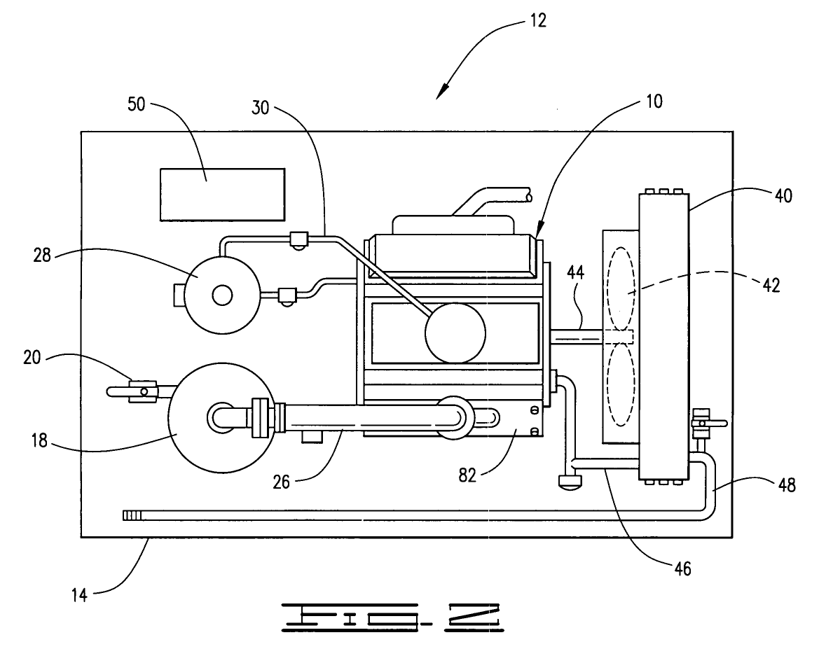

Compressor package 12 as illustrated is of a type particularly well adapted for use in recovering natural gas from a well, but may be used for other flammable gases or gases with elevated inlet pressures. The invention is not intended to be limited to the illustrated compressor package 12. FIGS. 1 and 2 have been greatly simplified to eliminate much of the piping and wiring associated with package 12. The omitted items are known in the art and are not necessary for an understanding of the invention.

In a typical package 12, such as that shown in FIGS. 1 and 2, compressor 10 is mounted on a skid or baseplate 14. An inlet tank and liquid separator 18 is also attached to skid 14. A valve 20 is in communication with tank 18 and is adapted for connection to the source of the gas to be compressed. In one embodiment, this gas would be natural gas from a wellhead (not shown), but compressor 10 and package 12 can be adapted to virtually any gas, and the invention is not intended to be limited to any particular application.

The top of tank 18 is connected to a compressor inlet manifold 82 mounted on a compressor head 24 on compressor 10 by a line 26. That is, line 26 is an inlet or suction line for compressor 10.

Positioned adjacent to tank 18 is a fuel vessel 28 which is adapted for connection to a fuel source, such as the natural gas wellhead. A line 30 connects fuel vessel 28 to carburetor 32 on the engine portion of compressor 10.

An aftercooler 40 is mounted on skid 14 and used to cool gas discharged from compressor 10. Aftercooler 40 is shown as a finned tube type with a cooling fan 42 associated therewith. Fan 42 may be driven by a drive shaft 44 extending from compressor 10. Aftercooler 40 may include an engine jacket water-cooling section to cool the engine and compressor sections of compressor 10.

A discharge line 46 connects the outlet of compressor 10 with aftercooler 40. An aftercooler outlet line 48 extends from aftercooler 40.

An electrical control panel 50 for controlling the apparatus may be positioned on skid 14. Control panel 50 is of a kind generally known in the art, and the connections thereto are omitted for clarity.

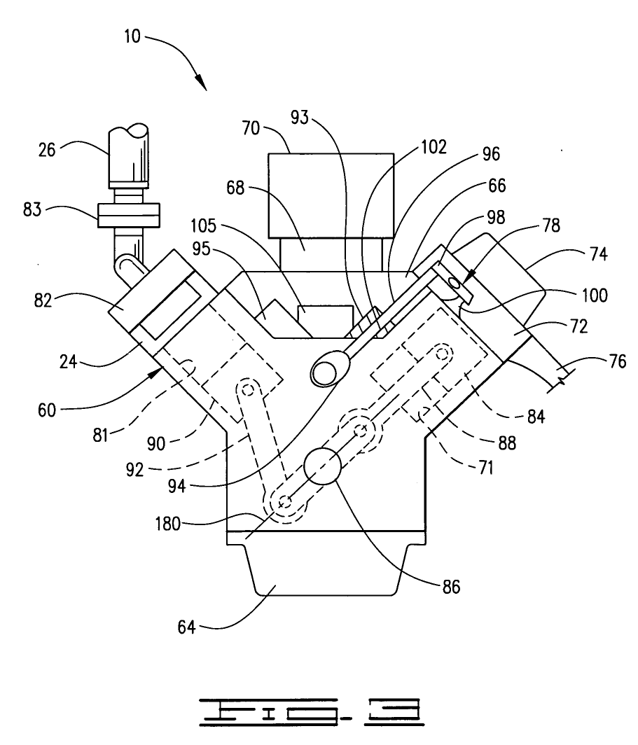

Compressor 10 is constructed using the general layout of a known internal combustion engine, such as, but not limited to, a 460 cubic inch Ford V-8 engine. The general V-shaped configuration of compressor 10 is shown in FIG. 3. Compressor 10 comprises a cylinder block 60 specifically designed to be used as a compressor on one side or bank and as an engine on the other side or bank. While the original engine cylinder block as used in some prior art compressors may be used, the preferred cylinder block is as described herein, and in U.S. patent application Ser. No. 11/247,108, assigned to the assignee hereof.

Below cylinder block 60 is an oil pan 64. At the upper end of cylinder block 60 is an engine intake manifold 66. Oil pan 64 and engine intake manifold 66 are standard components of the original Ford or other engine. A known carburetor 68 and air cleaner 70 are mounted on engine intake manifold 66.

Connected to cylinder block 60 on the right bank of cylinders 71, as viewed in FIG. 3, is a standard engine head 72 with a valve cover 74 thereon. An exhaust manifold 76 carries away the exhaust gases of the engine. This right side of compressor 10 remains basically a standard engine and includes valve train 78, as will be further discussed herein, and other engine components which are not illustrated, such as spark plugs, wiring, etc.

The left side of compressor 10, as viewed in FIG. 3, is used for gas compression. Compressor head 24 is attached to cylinder block 60 on the left bank of cylinders 81. Connected to compressor head 24 is compressor inlet manifold 82. Attached to compressor inlet manifold 82 is a flange to which inlet line 26 is connected. Compressor head 24, compressor inlet manifold 82 and flange 83 are of the kind described in the above-referenced patents to Waldrop.

Standard engine pistons 84 are reciprocably disposed in the cylinders 71 on the right bank of cylinder block 60. Thus, cylinders 71 may be described as engine cylinders 71. The engine pistons are connected to crankshaft 86 by connecting rods 88. Engine pistons 84 and connecting rods 88 are the original components of the engine on which compressor 10 is based. Crankshaft 86 is not the original, or a prior art V-8 crankshaft, but rather is a novel crankshaft as described herein for use with the V-8 cylinder block.

A plurality of compressor pistons 90 are reciprocably disposed in cylinders 81 in the left bank of cylinder block 60. Thus, cylinders 81 may be described as compressor cylinders 81. Each compressor piston 90 is connected to crankshaft 86 by additional connecting rods 92. Compressor pistons 90 are preferably specifically designed for gas compression, but connecting rods 92 may be the same as connecting rods 88 on the engine side of compressor 10. It is understood that compressor head 24 will have a plurality of compressor valves disposed therein associated with compressor pistons 90.

A plurality of bosses 93 and 95 are integrally cast into cylinder block 60 adjacent to engine cylinders 71 and compressor cylinders 81, respectively.

Valve train 78 of the engine side of compressor 10 includes a rotating cam 94 which engages a plurality of push rods 96. Push rods 96 in turn engage corresponding valve rocker arms 98 which actuate engine valves 100 in each cylinder in a manner known in the art. Valve springs are not shown.

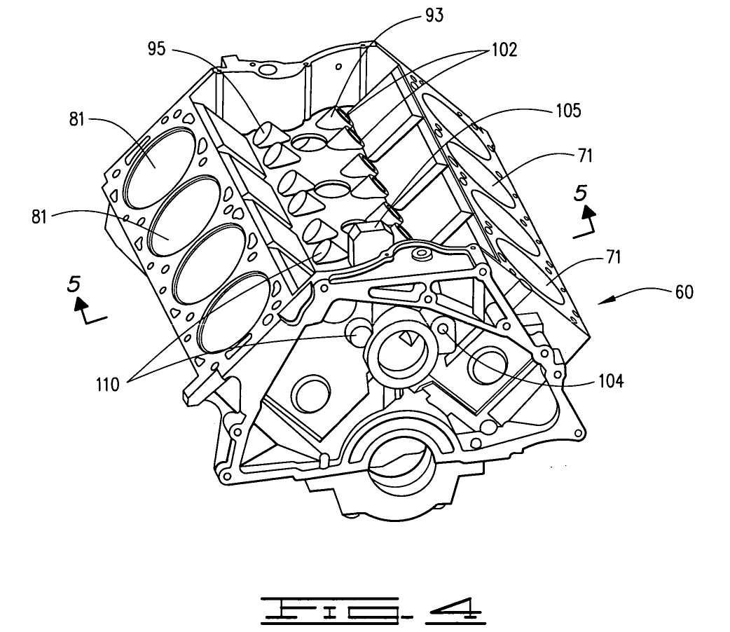

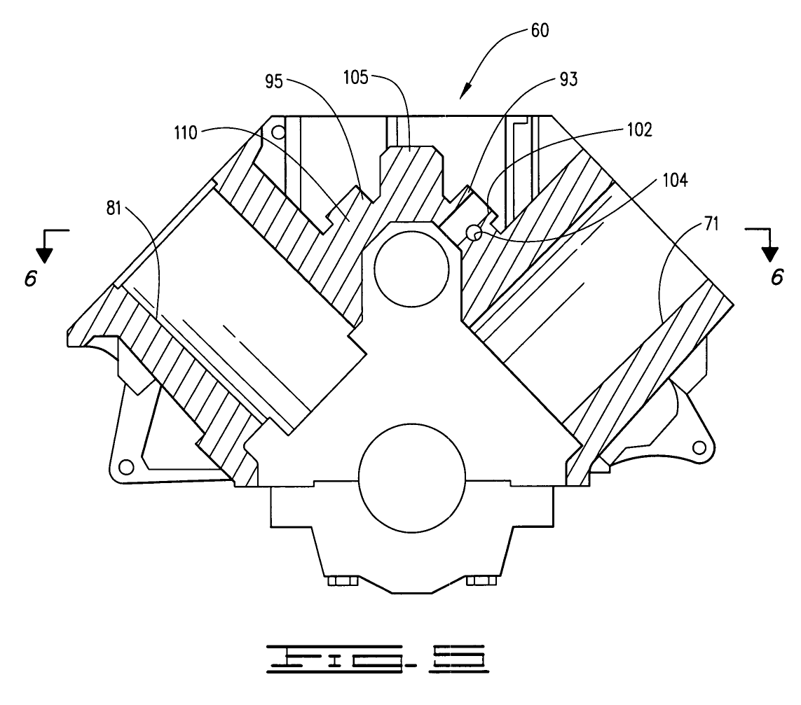

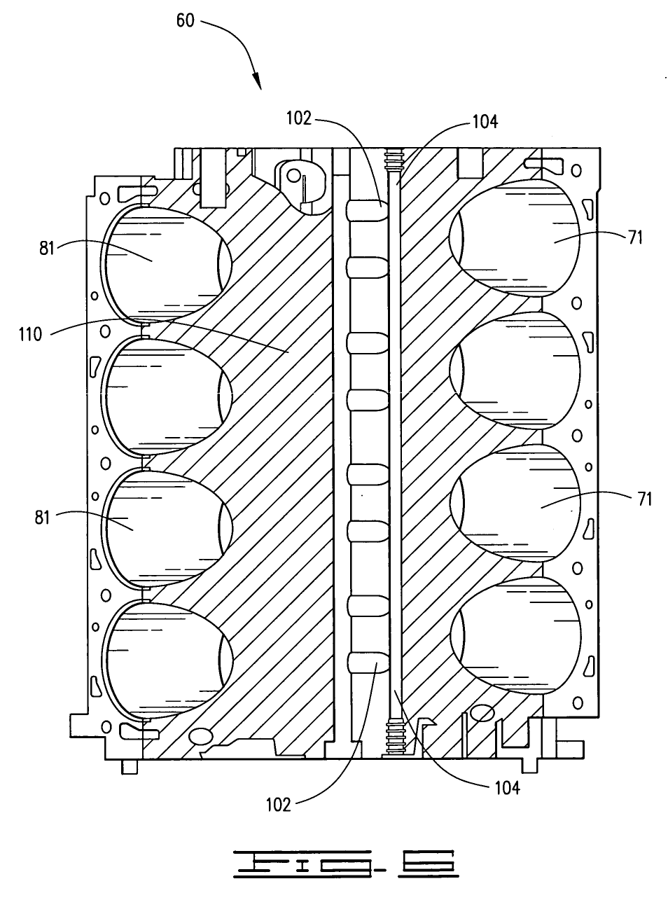

Referring to FIGS. 3-6, each push rod 96 is movably disposed in a corresponding push rod opening 102 machined in each boss 93 of cylinder block 60. A longitudinally extending oil port or gallery 104 intersects openings 102 and thus is in communication therewith. Engine lubricating oil is pumped by the engine oil pump (not shown) to port 104 and thus to openings 102 in a manner known in the art.

In some integral gas compressor and internal combustion apparatus made from previously existing engines, there are identical openings 102 in bosses 95 and a port 104 on the compressor side, all of the ports and openings being in communication with one another by crossover passages (not shown) in an enlarged section 105. Because there is no valve train, and thus no push rods, on the compressor side, it will be seen by those skilled in the art that the port and openings in previously-existing engines will result in an open path for oil to flow out onto the cylinder block if the port and openings are not closed. Not only does this cause a loss of oil pressure for the engine, the presence of oil on the compressor side is undesirable. Therefore, in previous apparatus of this type, port 104 and openings 102 have been plugged on the compressor side. This adds to the material and labor costs of the equipment and also requires leak testing.

Cylinder block 60 is preferably only machined for the engine valve train on the engine side of the block. That is, bosses 95 and enlarged section 105 are left solid and unmachined. The compressor side of cylinder block 60, as seen on the left sides of FIGS. 3-6, is not machined at all. That is, on cylinder block 60, there is a solid portion 110, and the block is designed to fully isolate oil in the engine side from the compressor side. Thus, there is no need to plug any port or openings to prevent the problems associated with prior compressors made from existing engine blocks.

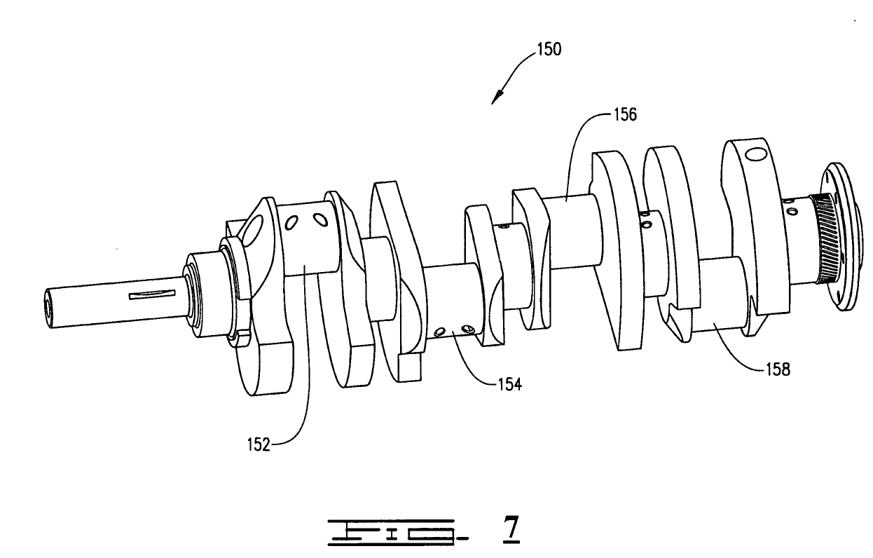

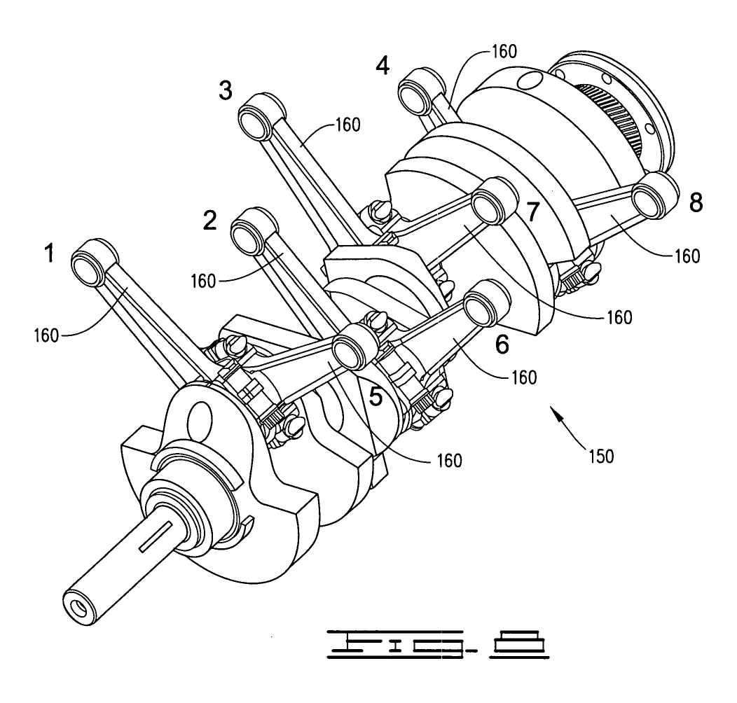

FIGS. 7 and 8 depict a typical prior art crankshaft 150 that would be used in a V-8 cylinder block. Crankshaft 150 has first, second, third and fourth journal locations 152, 154, 156 and 158, respectively. Journals 152 and 158 may be referred to as end journals, and journals 154 and 156 may be referred to as intermediate journals. As viewed in FIG. 7, journal 154 is positioned 90° clockwise from journal 152, journal 156 is positioned 270° clockwise from journal 152, and journal 158 is positioned 180° clockwise from journal 152. A pair of connecting rods 160 of a type known in the art would be mounted at each journal location to connect compressor pistons 90 and engine pistons 84 to crankshaft 150. Rotation of the crankshaft 150 will cause compressor pistons 90 and engine pistons 84 to move in the engine and compressor cylinders 71 and 81, respectively.

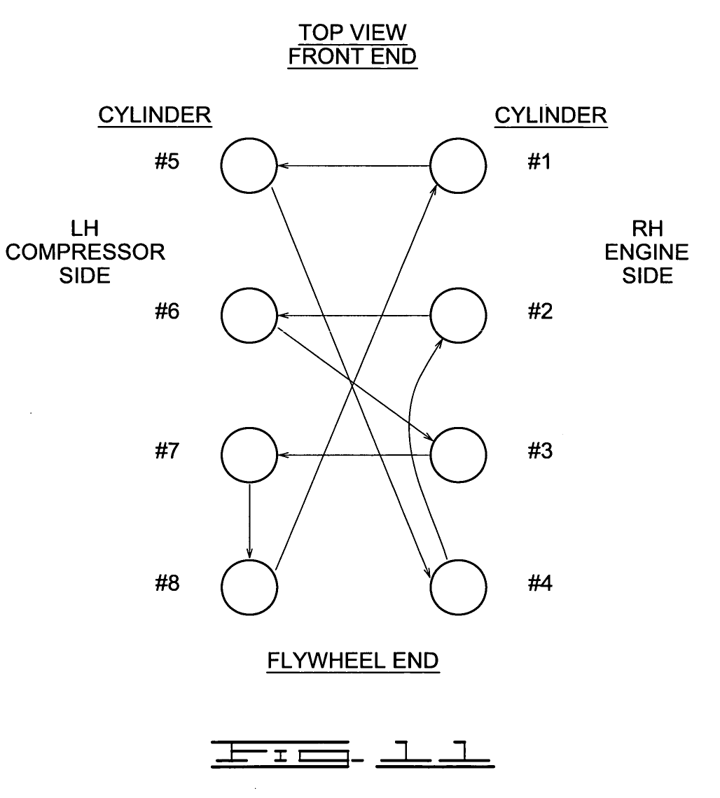

Referring now to FIG. 11, the engine and compression cylinders are represented by the circles identified with the numbers 1 through 8. During operation, the firing order for a V-8 engine would be 1-5-4-2-6-3-7-8 with prior art crankshaft 150. It is understood that the firing order refers to the normal operation of an engine in which a spark plug fires, causing a power stroke of an engine piston. This is what is meant when reference is made to the engine or an engine cylinder firing. A V-8 that has been converted to a compressor will therefore have “dead spots” in which the engine side does not fire. For example, when engine cylinder 1 fires, the crankshaft will rotate 90°, but instead of firing again, compressor piston in compressor cylinder 5 moves. Additional 90° rotation causes engine cylinder 4 to fire, and after an additional 90° of rotation, engine cylinder 2 fires. An additional 90° of rotation then causes movement of compressor piston in compressor cylinder 6, then after 90° engine cylinder 3 fires, then another 90° and the compressor in compressor cylinder 7 moves. An additional 90° of rotation causes the compressor piston in compressor cylinder 8 to move, and 90° further rotation causes engine cylinder 1 to fire again. Thus, with the prior art V-8 crankshaft, 270° of crankshaft rotation can occur between the times when the engine side fires. For example, after engine cylinder 3 fires, crankshaft 150 will rotate 270° before another engine cylinder fires, in this case engine cylinder 1. As such, when a V-8 engine is converted to a compressor, the apparatus can run rough because of the intermittent and uneven firing on the engine side.

To create a smoother running compressor, crankshaft 86 is used. Crankshaft 86 is similar to a crankshaft used in 4-cylinder engines, modified so that two connecting rods can be attached at each journal location. Crankshaft 86 has four journals, namely, first, second, third and fourth journals 162, 164, 166 and 168. Journals 162 and 168 may be referred to as end journals, while journals 164 and 166 may be referred to as intermediate journals. Crankshaft 86 has first and second ends 170 and 172 and is mounted in cylinder block 60 in a manner known in the art.

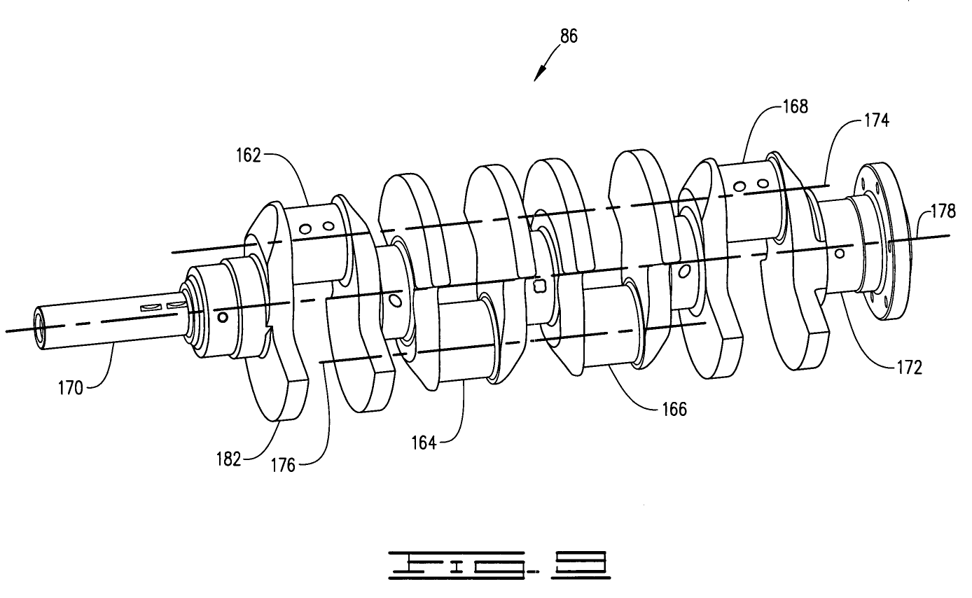

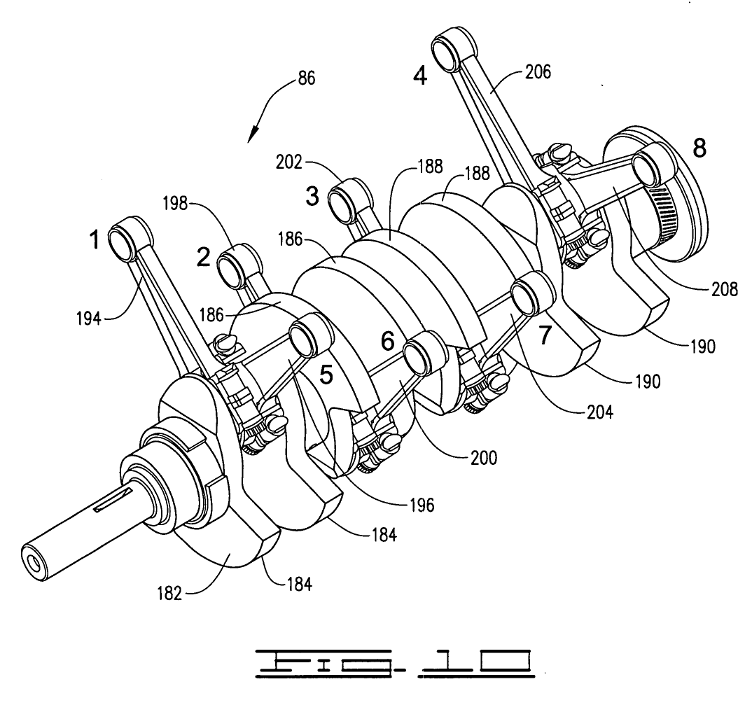

First and fourth journals 162 and 168 are coaxial, and thus have common longitudinal axis 174, second and third journals 164 and 166 are coaxial and have longitudinal axis 176. Ends 170 and 172, which may be referred to as mounting ends 170 and 172 have a longitudinal axis 178. Longitudinal axes 174, 176 and 178 lie in a common plane represented by line 180 in FIG. 3. As viewed in FIG. 9, longitudinal axis 174 is positioned above longitudinal axis 178, and longitudinal axis 176 is positioned below longitudinal axis 178. First and fourth journals 162 and 168 are, as viewed in FIGS. 9 and 10, above journals 164 and 166. Considering longitudinal axis 178 as a center, journals 164 and 166 are positioned 180° from journals 162 and 168.

Crankshaft 86 may have counterweights 182 of a type known in the art mounted thereto. As shown in FIG. 10, counterweights 182 may include four pairs of counterweights, namely, first, second, third and fourth pairs 184, 186, 188 and 190. Connecting rods 88 and 92, which may be connecting rods of a type generally used with a V-8, are mounted to crankshaft 86. Each journal 162, 164, 166 and 168 has two connecting rods mounted thereto, one connecting rod 88 and one connecting rod 92. Eight connecting rods, which may be referred to as connecting rods 194, 196, 198, 200, 202, 204, 206 and 208, are shown in FIG. 10. Connecting rods 194 and 196 are mounted to journal 162. Connecting rods 198 and 200 are connected to journal 164. Connecting rods 202 and 204 are mounted to journal 166. Connecting rods 206 and 208 are mounted to journal 168.

Each of connecting rods 92 is connected to either an engine piston 84 or compressor piston 90. For example, connecting rods 88 may comprise connecting rods 194, 198, 202 and 206 which may each be connected to an engine piston 84 which, in the schematic of FIG. 11, corresponds to engine pistons in the engine cylinders numbered 1, 2, 3, and 4. Connecting rods 92 may comprise connecting rods 196, 200, 204 and 208 which are connected to compressor pistons 90 which correspond to the numbers 5, 6, 7 and 8 in FIG. 11.

Compressor 10 runs more evenly and smoothly with crankshaft 86 than with a typical prior art V-8 crankshaft 150.

The engine cylinders 81 in the engine side of compressor 10 will fire every half rotation, or every 180° of rotation of crankshaft 86 so that there will be a power stroke on the engine side every half rotation of the crankshaft. Thus, the engine side will fire four times every 720° of rotation, just as with a typical crankshaft, but will run more evenly. The firing order on the engine side will be 1-3-4-2 and at any given time, two engine pistons 84 will cycle up and two will cycle down.

Because the engine side fires every 180° of rotation of crankshaft 86, there is no unevenness to the running of compressor 10. Each compressor piston 90 will go through an intake/exhaust cycle with each full rotation of crankshaft 86, and, as with engine pistons 84, two compressor pistons 90 will cycle up and two will cycle down at any given time. The compressor 10, because the engine side fires more evenly than with the prior art crankshaft, will run more efficiently, in that it will require less fuel, will produce fewer emissions, higher torque and create less wear. The compressor 10 will run more smoothly with less vibration, which will reduce maintenance costs.

While cylinder block 60 has been shown in the drawings with the engine side or section on the right and the compressor side or section on the left, these could be reversed by reversing the machining. That is, compressor 10 could be made with the engine side or section on the left and the compressor side or section on the right.

It will be seen, therefore, that the cylinder block and crankshaft for integral gas compressor and internal combustion engine of the present invention is well adapted to carry out the ends and advantages mentioned as well as those inherent therein. While a presently preferred embodiment of the apparatus has been shown for the purposes of this disclosure, numerous changes in the arrangement and construction of the parts may be made by those skilled in the art. All such changes are encompassed within the scope and spirit of the appended claims.

What is claimed is:

1. An integral gas compressor and internal combustion engine apparatus comprising:
a V-8 cylinder block defining a set of engine cylinders on a first side of the cylinder block and a set of engine cylinders on a second side of the cylinder block;
a crankshaft rotatably disposed in the cylinder block;
a compressor piston disposed in each compressor cylinder; and
an engine piston disposed in each engine cylinder wherein the crankshaft is connected to the engine pistons and the compressor pistons, and is journalled so that the engine cylinder will fire every half rotation of the crankshaft.

2. The apparatus of claim 1 further comprising a connecting rod connecting each of the compressor pistons and the engine pistons to the crankshaft.

3. The apparatus of claim 1 further comprising a plurality of counterweights mounted to the crankshaft.

4. The apparatus of claim 2, the connecting rods being connected to the crankshaft at journals on the crankshaft, the crankshaft having two end journals and two intermediate journals, wherein the two intermediate journals are coaxial and the two end journals are coaxial.

5. The apparatus of claim 4, wherein the two end journals are oriented 180° from the two intermediate journals.

6. An integral gas compressor and internal combustion engine comprising:
a V-8 cylinder block defining a plurality of compressor cylinders and engine cylinders;
a compressor piston in each compressor cylinder;
an engine piston in each piston cylinder; and
a crankshaft rotatably disposed in the cylinder block and connected to the engine pistons and the compressor pistons, wherein the crankshaft comprises a modified four cylinder crankshaft with four journal locations, the modified crankshaft being configured to carry two connecting rods at each journal location.

7. The apparatus of claim 6 wherein an engine cylinder will fire every half rotation of the modified crankshaft to cause a power stroke of an engine piston every half rotation of the crankshaft.

8. The apparatus of claim 6, wherein each compressor piston and each engine piston is connected to the crankshaft with a connecting rod.

9. The apparatus of claim 7 further comprising an engine valve associated with each engine piston and a compressor valve associated with each compressor piston.

10. An integral gas compressor and internal combustion engine apparatus comprising:
a V-8 cylinder block defining a plurality of compressor cylinders and a plurality of engine cylinders;
a compressor piston disposed in each compressor cylinder;
an engine piston disposed in each engine cylinder;
a crankshaft rotatably disposed in the engine block, the crankshaft having two end journals and two intermediate journals, the end journals being coaxial and the intermediate journals being coaxial; and
connecting rods for connecting each of the compressor and engine pistons to the crankshaft.

11. The apparatus of claim 10, each journal having two connecting rods mounted thereto.

12. The apparatus of claim 10, wherein the cylinder block has a pair of banks, and wherein the compressor cylinders are defined in one bank, and the engine cylinders are defined in the other bank.

13. The apparatus of claim 10 wherein an engine cylinder will fire every one-half rotation of the crankshaft.

14. An integral gas compressor internal combustion engine apparatus comprising:
a cylinder block defining four compressor cylinders and four engine cylinders;
an engine piston disposed in each engine cylinder;
a compressor piston disposed in each compressor cylinder;
a crankshaft with first, second, third and fourth journals, the first and fourth journals being coaxial, and the second and third journals being coaxial; and
a connecting rod for connecting each compressor piston and each engine piston to one of the journals.

15. The apparatus of claim 14 wherein the cylinder block has a V-8 configuration.

16. The apparatus of claim 14 the engine cylinders being defined in an engine portion and the compressor cylinders being defined in a compressor portion, the engine portion defining a valve train opening, wherein the compressor portion has no valve train opening.

17. The apparatus of claim 15 wherein each journal has a pair of connecting rods mounted thereon, one connected to an engine piston, and one connected to a compressor piston.

18. The apparatus of claim 15, wherein one of the engine pistons fires every half rotation of the crankshaft.

19. The apparatus of claim 15, the first and fourth journals comprising end journals, and the second and third journals comprising intermediate journals between the end journals.
